(19) United States
(12) Patent Application Publication
(10) Pub. No.: US 2020/0101959 A1
(43) Pub. Date: Apr. 2, 2020

(54) WATER SEPARATOR ASSEMBLY

(71) Applicant: Power Drives, Inc., Buffalo, NY (US)

(72) Inventors: Bradley R. Gates, Erie, PA (US); Kevin W. O'Neal, Erie, PA (US); Sean R. Jackson, Springboro, PA (US); Brandon Schwartz, Aledo, TX (US)

(21) Appl. No.: 16/589,417

(22) Filed: Oct. 1, 2019

Related U.S. Application Data
(60) Provisional application No. 62/739,515, filed on Oct. 1, 2018.

(51) Int. Cl. B60T 17/00; B01D 53/26; B01D 53/24

(52) U.S. Cl. CPC B60T 17/004; B01D 53/24; B01D 53/26

(57) ABSTRACT

A water separator assembly for an air braking system of a vehicle, including an inlet conduit, a water separator connected to the inlet conduit, an outlet conduit connected to the water separator, and an adjustable bracket operatively arranged to connect the water separator to a deck of the vehicle.

### CROSS-REFERENCE TO RELATED APPLICATIONS

This application claims the benefit under 35 U.S.C. § 119(e) of U.S. Provisional Application No. 62/739,515, filed Oct. 1, 2018, which application is incorporated herein by reference in its entirety.

### FIELD

The present disclosure relates to water separators, and, more particularly, to a water separator assembly to be implemented with a braking system of a locomotive.

### BACKGROUND

Brakes are used on the cars of railway trains to enable deceleration, control acceleration (downhill) or to keep them standing when parked. While the basic principle is familiar from road vehicle usage, operational features are more complex because of the need to control multiple linked carriages and to be effective on vehicles left without a prime mover. Clasp brakes are one type of braking system historically used on trains. Another, more common type of braking system is the Westinghouse Air Brake Company air brake system. In this system, air reservoirs are provided on every vehicle and the locomotive charges the train pipe with a positive air pressure, which releases the vehicle brakes and charges the air reservoirs on the vehicles. If the driver applies the brakes, his brake valve releases air from the train pipe, and triple valves at each vehicle detect the pressure loss and admit air from the air reservoirs to the brake cylinders, applying the brakes. The Westinghouse air brake system uses smaller air reservoirs and brake cylinders than the corresponding vacuum equipment because a moderately high air pressure can be used. One enhancement of the automatic air brake is to have a second air hose (the main reservoir or main line) along the train to recharge the air reservoirs on each wagon. This air pressure can also be used to operate loading and unloading doors on wheat wagons and coal and ballast wagons. On passenger coaches, the main reservoir pipe is also used to supply air to operate doors and air suspension.

One issue with the use of air brakes on locomotives is water. Since air contains moisture in the form of water vapor, when the air cools the water vapor may condense into water. This water can damage air brake controls and equipment and is often blown out of the system through a release valve. However, blowing the water out of the system releases compressed air thus reducing air pressure in the system, and is not very effective.

Thus, there has been a long-felt need for a water separator assembly that is arranged in line with the air braking system and effectively removes water from the compressed air without the need to release compressed air to the atmosphere.

### SUMMARY

According to aspects illustrated herein, there is provided a water separator assembly for an air braking system of a vehicle, comprising an inlet conduit, a water separator connected to the inlet conduit, an outlet conduit connected to the water separator, and an adjustable bracket operatively arranged to connect the water separator to a deck of the vehicle.

According to aspects illustrated herein, there is provided a water separator assembly for an air braking system of a vehicle, comprising an inlet conduit operatively arranged to be connected to an intercooler of the air braking system, a water separator, including an inlet connected to the inlet conduit, a drain, a heating pad, and an outlet, an outlet conduit connected to the outlet and operatively arranged to be connected to a main air reservoir of the air braking system, and an adjustable bracket operatively arranged to connect the water separator to a deck of the vehicle, the adjustable bracket including a vertical member operatively arranged to be secured to the water separator, and a base member connected to the vertical member, the base member operatively arranged to be connected to the deck of the vehicle.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of a water separator assembly;

FIG. 2 is a rear perspective view of the water separator assembly shown in FIG. 1;

FIG. 3A is a front elevational view of the water separator assembly shown in FIG. 1;

FIG. 3B is a right side elevational view of the water separator assembly shown in FIG. 1;

FIG. 3C is a left side elevational view of the water separator assembly shown in FIG. 1;

FIG. 4 is an exploded view of the water separator assembly shown in FIG. 1;

FIG. 5A is a perspective view of an adjustable bracket, as shown in FIG. 1;

FIG. 5B is a rear elevational view of the adjustable bracket shown in FIG. 5A;

FIG. 5C is a left side elevational view of the adjustable bracket shown in FIG. 5A;

FIG. 5D is a right side elevational view of the adjustable bracket shown in FIG. 5A;

FIG. 6 shows a locomotive having a prior art air braking system;

FIG. 7 shows a prior art air braking system of a locomotive;

FIG. 8 shows the water separator assembly shown in FIG. 1 operatively arranged on a braking system of a locomotive;

FIG. 9 shows an air reservoir of a locomotive;

FIG. 10 shows a circuit breaker box with thermostatic switch for a heating pad of the water separator assembly shown in FIG. 1;

FIG. 11 shows a prior art air braking system;

FIG. 12 shows the prior art air braking system shown in FIG. 11;

FIG. 13 shows the prior art air braking system shown in FIG. 11;

FIG. 14 shows the prior art air braking system with the existing plumbing removed;

FIG. 15 shows the prior art air braking system with the existing plumbing removed;

FIG. 16 shows the installation of the water separator assembly shown in FIG. 1 on the air braking system of a locomotive;

FIG. 17 shows the installation of the water separator assembly shown in FIG. 1 on a braking system of a locomotive;

FIG. 18 shows the installation of the water separator assembly shown in FIG. 1 on the air braking system of a locomotive;

FIG. 19 shows the water separator assembly shown in FIG. 1 installed on the air braking system of a locomotive;

FIG. 20 shows an ambient air temperature switch;

FIG. 21 shows an ambient air temperature switch;

FIG. 22 shows a drain tube; and,

FIG. 23 shows a cross-sectional schematic view of the water separator shown in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and, a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element. A similar interpretation is intended when the phrase “used in at least one of:” is used herein. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

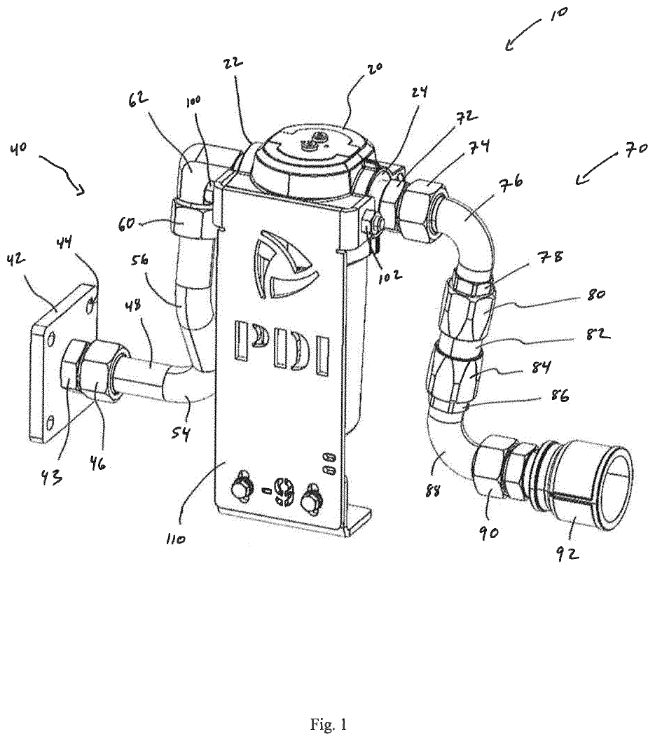

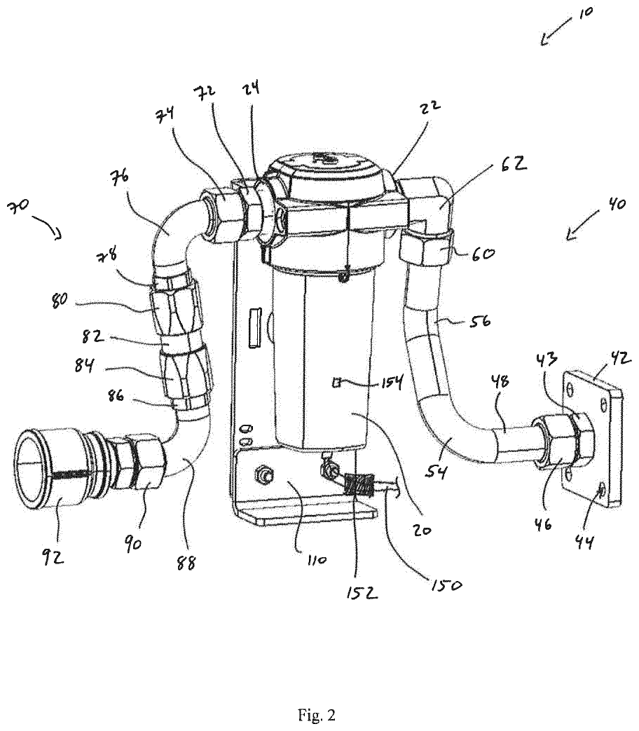

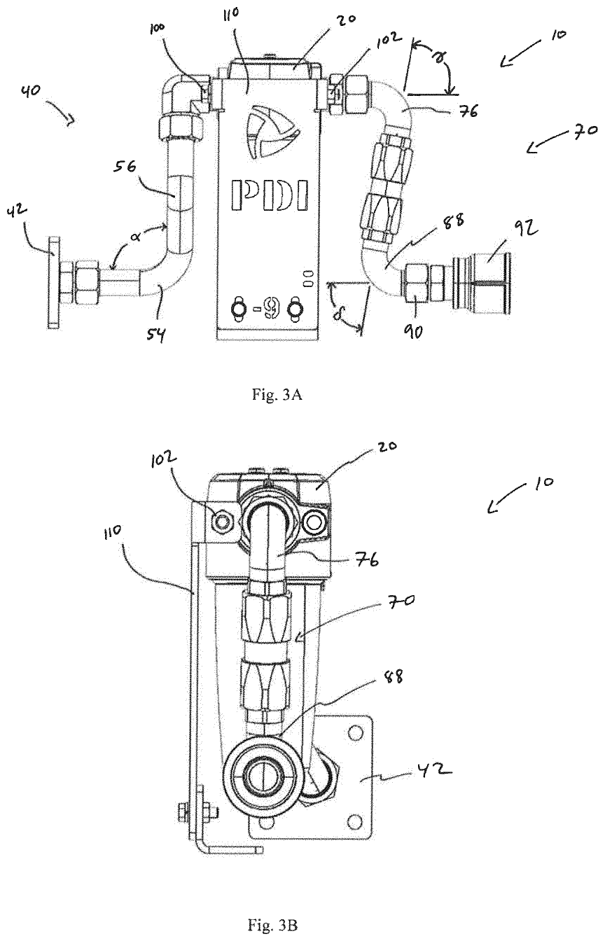

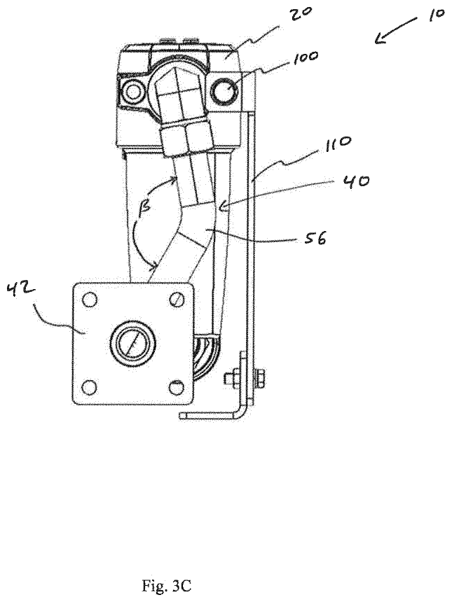

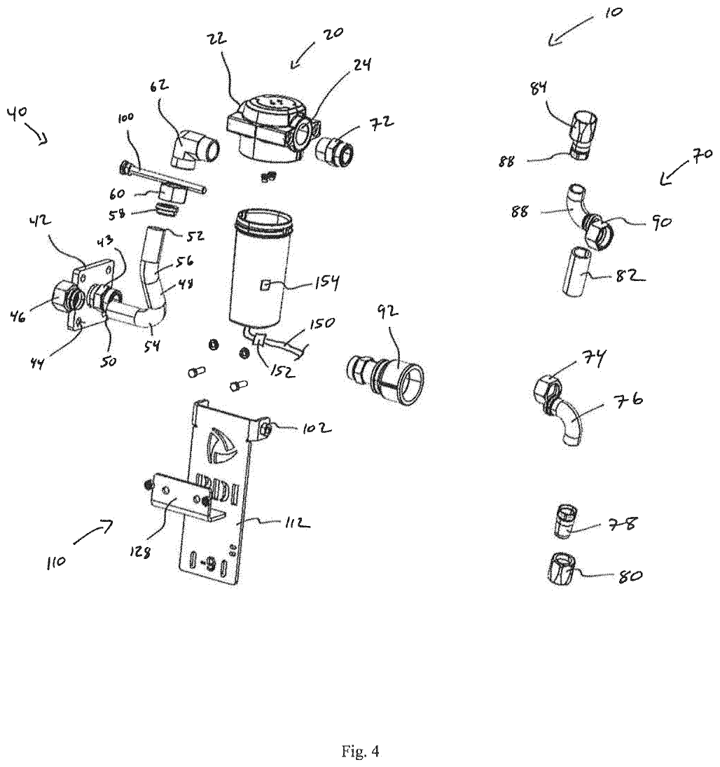

Adverting now to the figures, FIG. 1 is a front perspective view of water separator assembly 10. FIG. 2 is a rear perspective view of water separator assembly 10. FIG. 3A is a front elevational view of water separator assembly 10. FIG. 3B is a right side elevational view of water separator assembly 10. FIG. 3C is a left side elevational view of water separator assembly 10. FIG. 4 is an exploded view of water separator assembly 10. Water separator assembly 10 generally comprises water separator 20, inlet conduit 40, outlet conduit 70, and adjustable bracket 110. Water separator assembly 10 is specifically designed to easily replace existing plumbing on a locomotive to separate water from the compressed air braking system thereon. The following description should be read in view of FIGS. 1-4.

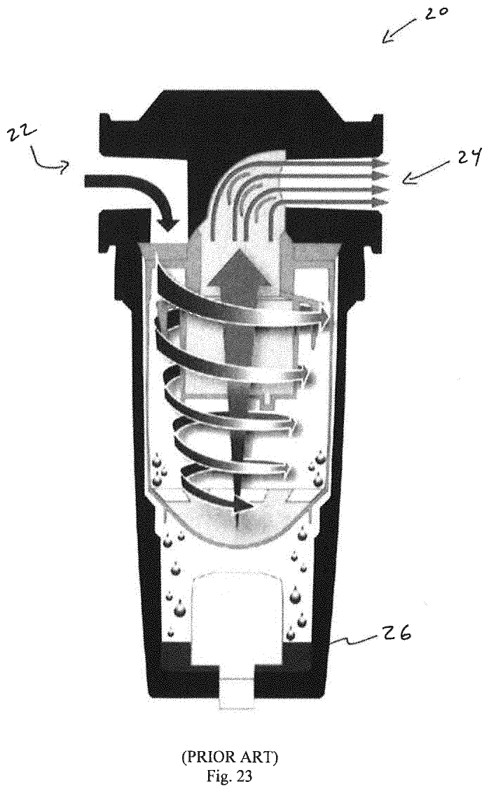

Water separator 20 is generally a water separator that removes liquid from compressed air. Water separator 20 comprises inlet 22 and outlet 24. Inlet 22 is connected to inlet conduit 40 and outlet 24 is connected to outlet conduit 70. Water separator 20 is mounted to the locomotive via adjustable bracket 110. Specifically, water separator 20 is secured to adjustable bracket 110 via bolt 100 and nut 102. Water separator 20 may comprise any water separator suitable for removing water from compressed air, for example, a centrifugal water separator. An example embodiment of water separator 20 will be discussed in greater detail with respect to FIG. 23.

Inlet conduit 40 is arranged to connect water separator 20 to intercooler 5, as will be discussed in greater detail below. Inlet conduit 40 comprises flange 42, fitting 46, pipe 48, fitting 60, and elbow 62. Flange 42 is arranged to be secured to intercooler 5. In the embodiment shown, flange 42 has a square or rectangular geometry including four through-bores 44. Flange 42 is arranged to be secured to intercooler 5 via through-bores 44 and bolts; however, it should be appreciated that any suitable means for fluidly connecting inlet conduit 40 to intercooler 5 may be used, for example, welding, rivets, screws, etc. Additionally, it should be appreciated that flange 42 may have any geometry, for example, triangular, ovular, ellipsoidal, trapezoidal, etc., as well as any number of through-bores 44, for example, one or more through-bores, suitable for fluidly connecting inlet conduit 40 to intercooler 5. Flange 42 may further comprise reducer 43, or a component that reduces the pipe size from a larger inner diameter to a smaller inner diameter.

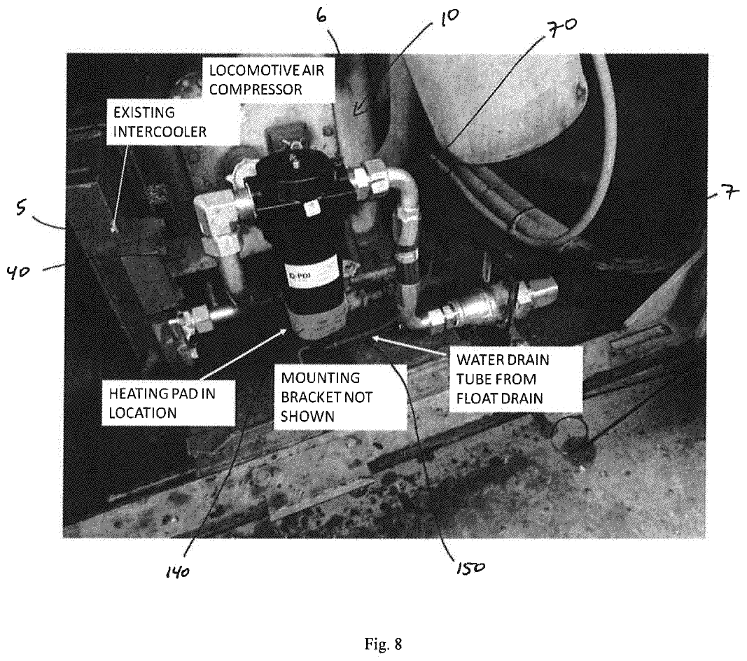

Pipe 48 comprises end 50 and end 52. End 50 is connected to flange 42 via fitting or union 46. End 52 is connected to elbow 62 via fitting or union 60. Fitting 46 may be a reducer, or a component that reduces the pipe size from a larger inner diameter to a smaller inner diameter. Elbow 62 is connected to inlet 22. Pipe 48 further comprises bend 54 and bend 56. As shown in FIG. 3A, in an X-Y plane seen in the front elevational view, bend 54 is arranged at angle α. In an example embodiment, angle α is 90°. In an example embodiment, angle α is greater than 90°. In an example embodiment, angle α is less than 90°. As shown in FIG. 3C, in a Z-Y plane seen in the left side elevational view, bend 56 is arranged at angle β. In an example embodiment, angle β is greater than 135° and less than 145°. In an example embodiment, angle β is greater than or equal to 145°. In an example embodiment, angle β is less than or equal to 135°. Inlet conduit 40 is specifically designed with bends 54 and 56 at angles α and β, respectively, such that water separator assembly 10 may fit within the existing confines of the locomotive and be fluidly connected with intercooler 5 (see FIGS. 8, 18, and 19).

Outlet conduit 70 is arranged to connect water separator 20 and to existing to plumbing 7 and the main air reservoir(s), as will be discussed in greater detail below. Outlet conduit 70 comprises fitting 72, fitting or union 74, elbow 76, fitting 78, fitting or union 80, pipe or hose 82, fitting or union 84, fitting 86, elbow 88, fitting or union 90, and fitting 92. Fitting 72 is connected to outlet 24. Elbow 76 is connected to fitting 72 via fitting 74. As shown in FIG. 3A, in an X-Y plane seen in the front elevational view, elbow 76 is arranged at angle γ. In an example embodiment, angle γ is greater than 75° and less than 85°. In an example embodiment, angle γ is greater than or equal to 85°. In an example embodiment, angle γ is less than or equal to 75°. Fitting 78 is connected to elbow 76. Fitting 78 may be a reducer, or a component that reduces the pipe size from a larger inner diameter to a smaller inner diameter. Pipe 82 is connected to fitting 78 via fitting or union 80. Fitting 86 is connected to pipe 82 via fitting or union 84. Fitting 86 may be a reducer arranged in reverse, to expand the pipe size from a smaller inner diameter to a larger inner diameter (i.e., an expander or diffuser). Elbow 88 is connected to fitting 86. As shown in FIG. 3A, in an X-Y plane seen in the front elevational view, elbow 88 is arranged at angle δ. In an example embodiment, angle δ is greater than 75° and less than 85°. In an example embodiment, angle δ is greater than or equal to 85°. In an example embodiment, angle δ is less than or equal to 75°. Elbow 88 is connected to fitting 92 via fitting or union 90. Fitting 92 is fluidly connected to existing plumbing 7 (see FIGS. 8, 16-17, and 19). Fitting 92 may be a reducer arranged in reverse, to expand the pipe size from a smaller diameter to a larger diameter (i.e., an expander or diffuser).

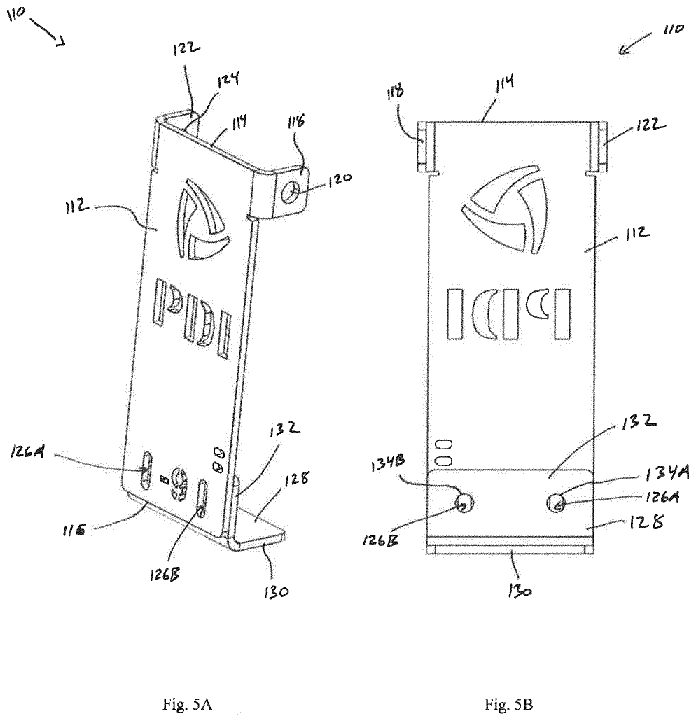

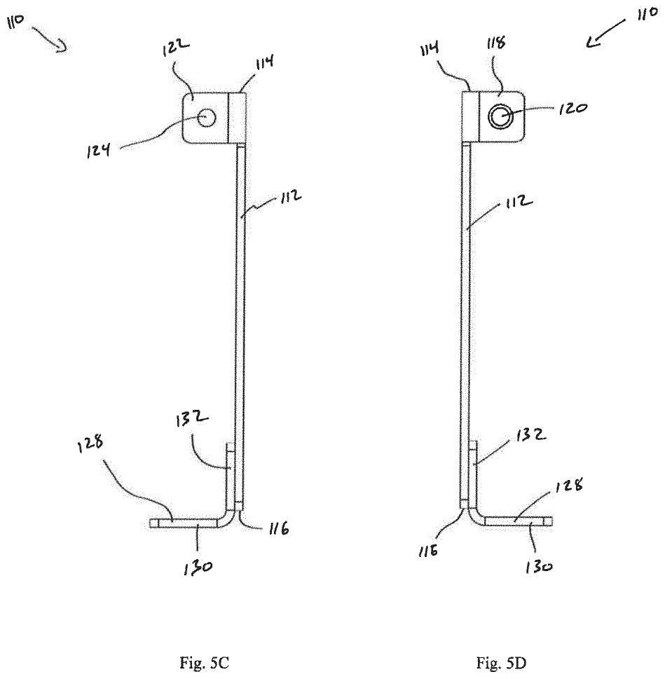

FIG. 5A is a perspective view of adjustable bracket 110. FIG. 5B is a rear elevational view of adjustable bracket 110. FIG. 5C is a left side elevational view of adjustable bracket 110. FIG. 5D is a right side elevational view of adjustable bracket 110. Adjustable bracket 110 generally comprises vertical member 112 and base member 128. The following description should be read in view of FIGS. 1-5D.

Vertical member 112 is generally rectangular and comprises top 114, bottom 116, flange 118, and flange 122. It should be appreciated that vertical member 112 may comprise any suitable geometry, for example, triangular, square, ovular, ellipsoidal, trapezoidal, etc. Flange 118 is arranged proximate top 114 and extends substantially perpendicular to vertical member 112. In an example embodiment, flange 118 extends from vertical member 112 non-perpendicularly. Flange 118 comprises through-bore 120. Flange 122 is arranged proximate top 114 and extends substantially perpendicular to vertical member 112. In an example embodiment, flange 122 extends from vertical member 112 non-perpendicularly. Flange 122 comprises through-bore 124. Flanges 118 and 122 are arranged to secure vertical member 112 to water separator 20. Specifically, bolt 100 is fed through flange 122, specifically through-bore 124, through water separator 120, and then through flange 118, specifically through-bore 120, where nut 102 is then threadably secured thereon. Vertical member 112 further comprises slots 126A and 126B, which are arranged proximate bottom 116. Slots 126A and 126B are arranged to align with through-bores 134A and 134B of base member 128, respectively, such that the length of adjustable bracket 110 can be adjusted.

Base member 128 comprises horizontal component 130 and vertical component 132. Vertical component 132 is operatively arranged to abut against vertical member 112. Vertical member 112 may be slidingly engaged with vertical component 132 or fixedly secured to vertical component 132. Horizontal component 130 is arranged substantially perpendicular to vertical component 132. In an example embodiment, horizontal component 130 is not arranged substantially perpendicular to vertical component 132. Horizontal component 130 is arranged to be fixedly secured to the deck of the locomotive using any suitable means, for example, bolts, rivets, screws, welding, etc. Vertical component 132 comprises through-bores 134A and 134B, which are arranged to align with slots 126A and 126B, respectively. Vertical member 112 is secured to vertical component via bolts which are fed through respective slots 126A-B and through-bores 134A-B. To lengthen or shorten adjustable bracket 110, the bolts should be loosened and vertical member 112 is displaced upwards or downwards relative to vertical component 132 until the desired length is reached. Then bolts are tightened thereby fixedly securing vertical member 112 to vertical component 132.

The design of adjustable bracket 110 allows for easy installation of water separator assembly 10 onto a locomotive since water separator 20 can secured to the deck at any height, as will be discussed in greater detail below.

FIG. 6 shows locomotive 1 having prior art air braking system 9. Locomotive 1 generally comprises deck 2, main air reservoir 3, and main air reservoir 4. Main air reservoirs 3 and 4 are arranged below deck 2.

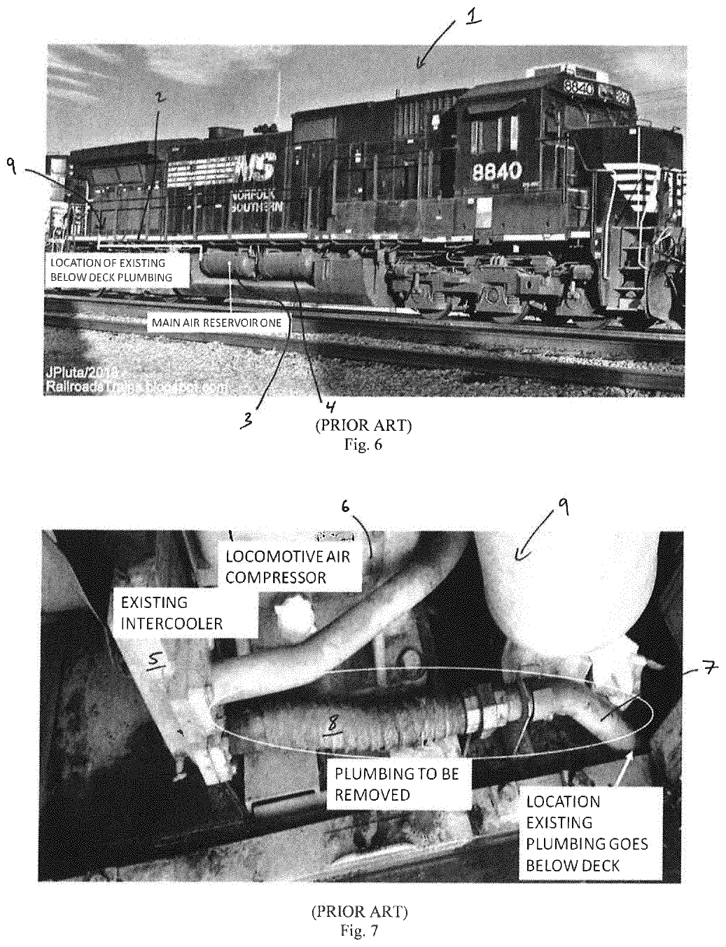

FIG. 7 shows prior art air braking system 9. Prior art air braking system 9 generally comprises intercooler 5, compressor 6, and existing plumbing 7 and 8. Water separator assembly 10 is operatively arranged to replace existing plumbing 8, as will be discussed in greater detail below.

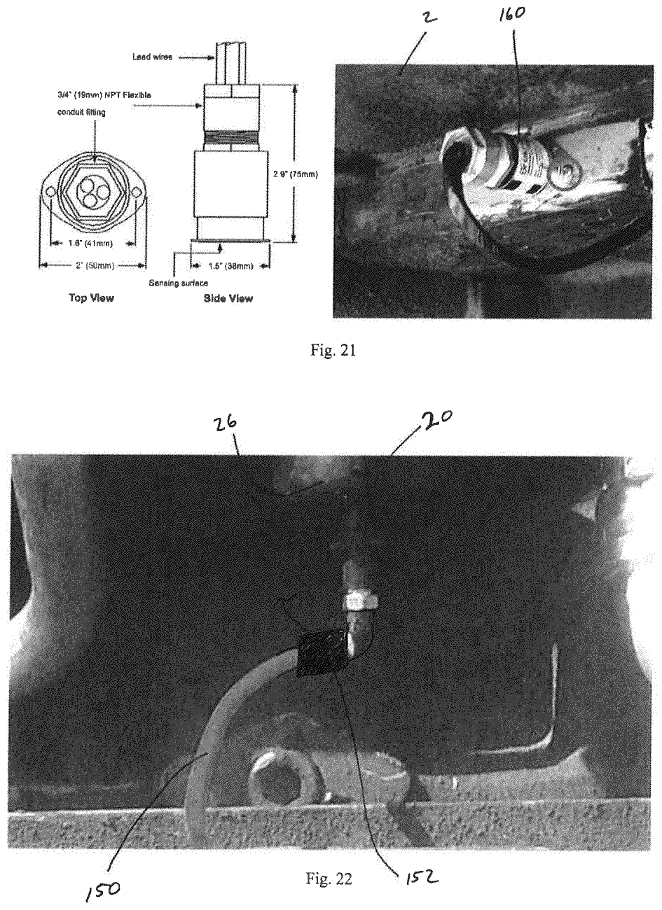

FIG. 8 shows water separator assembly 10 operatively arranged on a braking system of locomotive 1. As shown, existing plumbing 8 has been removed and replaced with water separator assembly 10, as will be discussed in greater detail below. In FIG. 8, adjustable bracket 110 has been removed for a better view of water separator 20, the connection of inlet conduit 40 to intercooler 5, and the connection of outlet conduit 70 to existing plumbing 7. Water separator assembly 10 may further comprise heating pad 140 and drain tube 150. Heating pad 140 is arranged on water separator 20 to prevent water in the drain from freezing in cold weather. Heating pad 140 may run continuously or may be connected to a thermostat or ambient air temperature switch 160 (see FIGS. 20-21) as will be discussed in greater detail below. Drain tube 150 is connected to water drain 26 of water separator 20 and is operatively arrange to drain water therefrom (see FIG. 22).

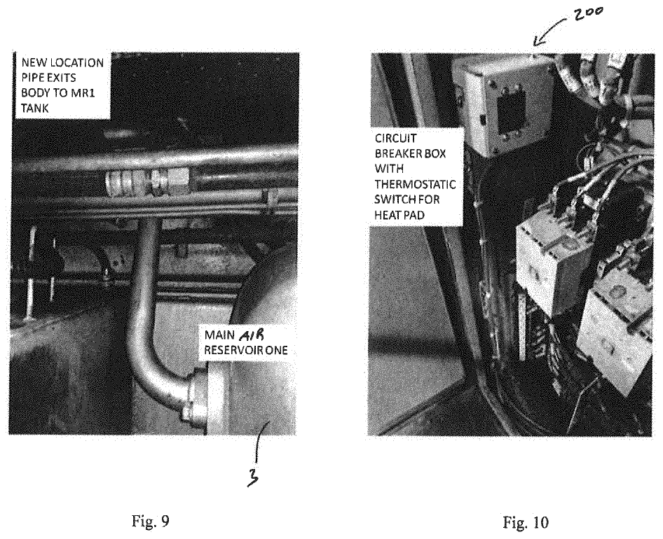

FIG. 9 shows air reservoir 3 of locomotive 1, which is arranged below deck 2. Air reservoir 3 may be connected to existing plumbing 7 and thus outlet conduit 70.

FIG. 10 shows circuit breaker box 200 with a thermostatic switch for heating pad 140 of water separator assembly 10. The thermostatic switch may connect heating pad 140 with ambient air temperature switch 160 such that, heating pad 140 is switched on or off based on the ambient air temperature. For example, when the ambient air temperature falls below a predetermined temperature, e.g., the ambient air temperature is less than or equal to 40° Fahrenheit, heating pad 140 is switched on, and when the ambient air temperature rises above a predetermined temperature, e.g., the ambient air temperature is greater than 40° Fahrenheit, heating pad 140 is switched off.

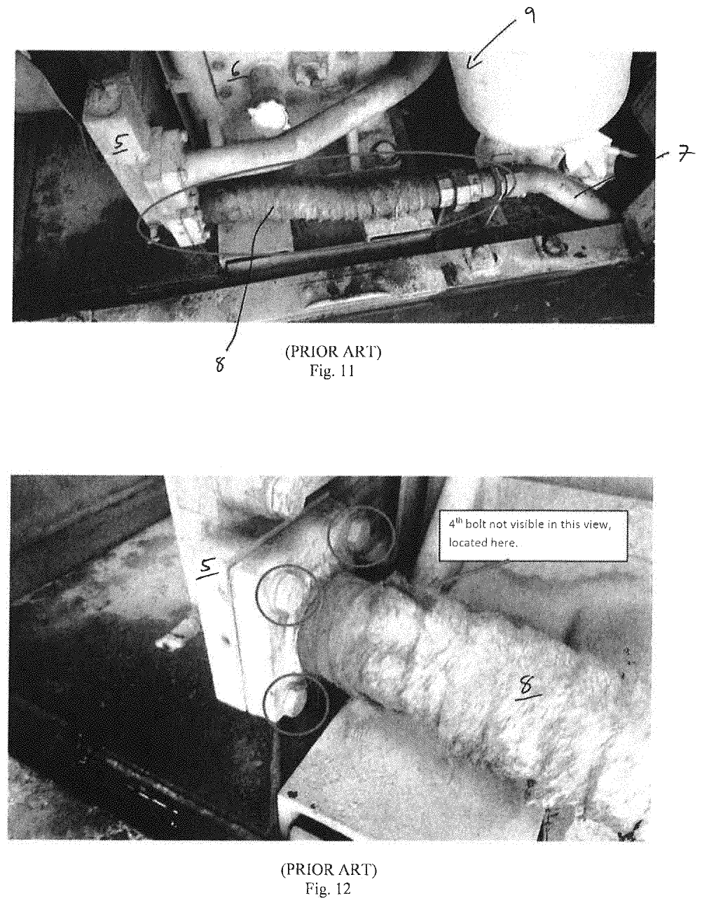

FIG. 11 shows prior art air braking system 9. As previously discussed, prior art air braking system 9 comprises intercooler 5, compressor 6, and existing plumbing 7 and 8. The subsequent description and figures illustrate how existing water separator assembly 10 is installed, thereby replacing existing plumbing 8. In the first step of installing water separator assembly 10, existing plumbing 8 is located and removed.

FIG. 12 shows prior art air braking system 9. As shown, the four bolts which secure the existing flange of existing plumbing 8 to intercooler 5 are removed.

FIG. 13 shows prior art air braking system 9. The pipe union shown, which connects existing plumbing 8 to existing plumbing 7, is loosened.

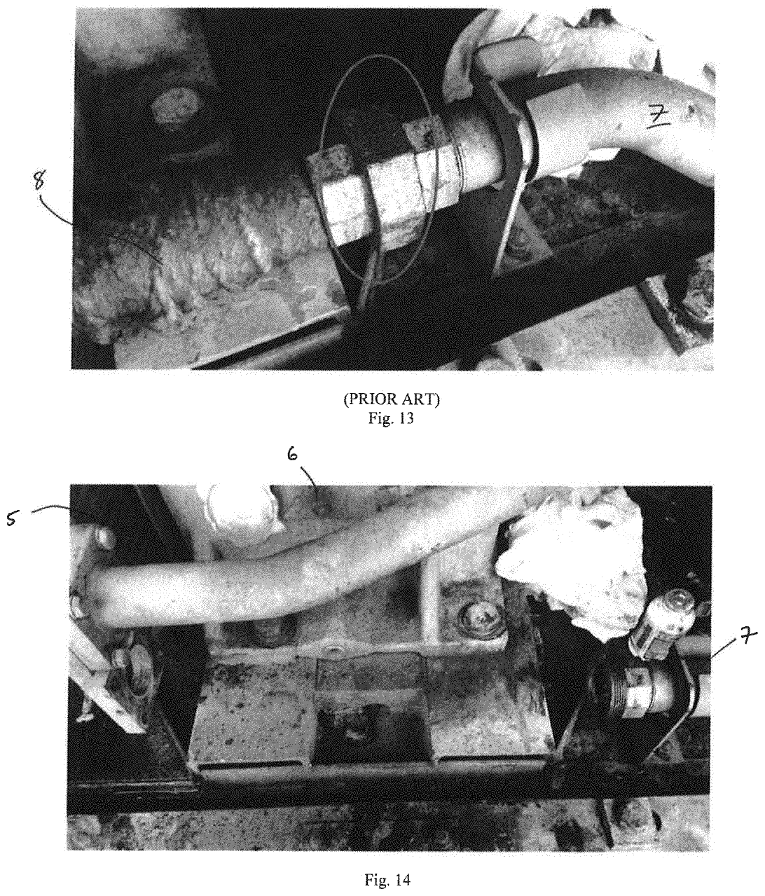

FIG. 14 shows prior art air braking system 9 with existing plumbing 8 removed from intercooler 5 and existing plumbing 7.

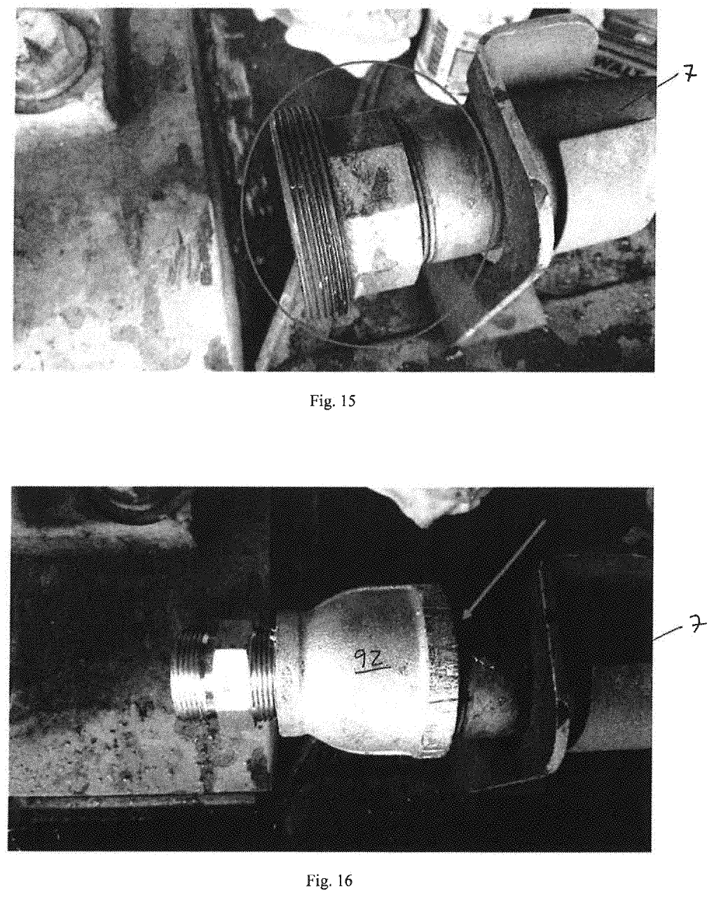

FIG. 15 shows prior art air braking system 9 with existing plumbing 8 removed from intercooler 5 and existing plumbing 7. As shown, the remaining half of the pipe union is removed from existing plumbing 7.

FIG. 16 shows the installation of water separator assembly 10 on the air braking system of locomotive 1. As shown, fitting 92 is connected to the end of existing plumbing 7. In an example embodiment, fitting 92 is threadably connected to a threaded end of existing plumbing 7, via two inch National Pipe Taper (NPT) thread. In an example embodiment, fitting 92 is soldered to existing plumbing 7. It should be appreciated that any suitable means for fluidly connecting fitting 92 to existing plumbing 7 may be used. In an example embodiment, a suitable pipe sealant may be used on the threading.

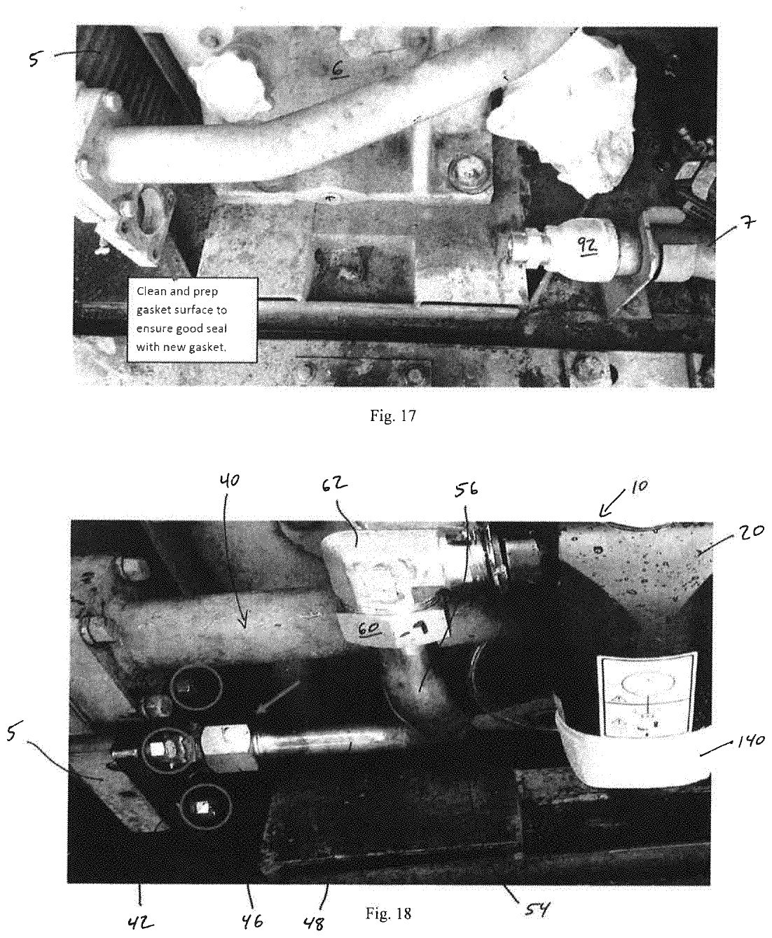

FIG. 17 shows the installation of water separator assembly 10 on the air braking system of locomotive 1. As shown, the gasket surface of intercooler 5 is cleaned and prepared to ensure a good seal with flange 42. A gasket may be arranged between the gasket surface of intercooler 5 and flange 42.

FIG. 18 shows the installation of water separator assembly 10 on the air braking system of locomotive 1. As shown, inlet conduit 40 is connected to intercooler 5. Specifically, flange 42 is fluidly connected to intercooler 5 via bolts and a new gasket. Bends 54 and 56 allow water separator assembly 10 to be installed without interfering with existing hardware and plumbing of locomotive 1. A thread locker may be applied to the bolts of flange 42.

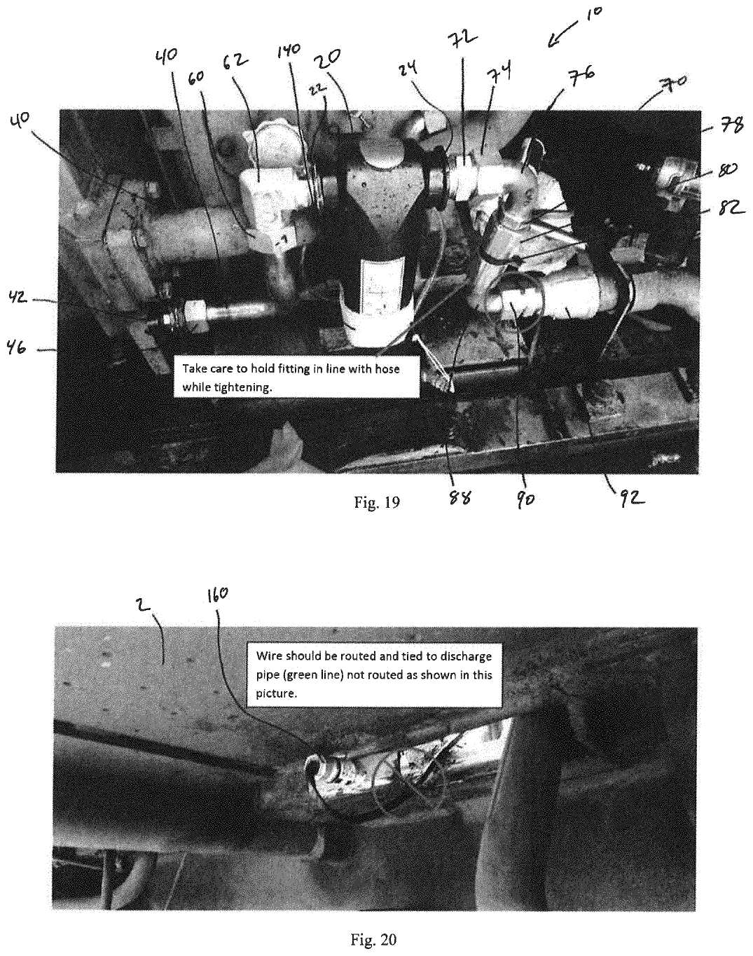

FIG. 19 shows water separator assembly 10 installed on the air braking system of locomotive 1. As shown, after inlet conduit 40, water separator 20, and adjustable bracket 110 (not shown) are installed, outlet conduit 70 is then installed to connect water separator 10 with existing plumbing 7.

FIG. 20 shows ambient air temperature switch 160. FIG. 21 shows ambient air temperature switch 160. Ambient air temperature switch 160 is mounted to and/or under deck 2 of locomotive 1. Ambient air temperature switch 160 is electrically connected to circuit breaker box 200, specifically, thermostatic switch for heating pad 140. In an example embodiment, ambient air temperature switch 160 is electrically connected to heating pad 140. Ambient air temperature switch 160 may be mounted to deck 2 via any suitable means, for example, bolts, screws, rivets, welding, soldering, etc.

FIG. 22 shows drain tube 150. Drain tube 150 is fluidly connected to drain 26 of water separator 20 and allows water to drain therefrom. Drain tube 150 may be routed to the floor drain proximate compressor 6. In some embodiments, water separator assembly 10 further comprises automatic water drain valve 152 fluidly connected to drain 26 of water separator 20. Automatic water drain valve 152 may be electrically connected to a control panel, for example, a control panel within circuit breaker box 200 via an electrical conduit. Automatic water drain valve 152 is arranged to open when the condensed water level in water separator 20 reaches a predetermined level, thereby draining the water from drain 26. In some embodiments, automatic water drain valve 152 may be in communication with water sensor 154 arranged in and/or on water separator 200. For example, when the water level in drain 26 reaches a predetermined height, sensor 154 sends a signal to the control panel (i.e., circuit board). The control panel then sends a signal to automatic water drain valve 152 to open, thereby draining the water in drain 26. It should be appreciated that sensor 154 may comprise any sensor suitable for detecting that the water level 26 has reached a predetermined height (or volume) and sending a signal indicating such to a control panel. Automatic water drain valve 152 is set to be closed, and upon receiving a signal to open, remains open for a predetermined period of time. For example, automatic water drain valve 152 may be connected to a circuit board including a digital timer, wherein after a first predetermined period of time (e.g., 10 minutes), automatic water drain valve 152 receives a signal to open, and remains open for a second predetermined period of time (e.g., 3 second). In some embodiments, based on the volume of water needed to trigger an open signal, automatic water drain valve 152 may stay open for 3 seconds which is suitable to completely drain that volume of water. In an example embodiment, a solenoid opens automatic water drain valve 152. However, it should be appreciated that automatic drain valve 152 may be any valve suitable for opening in response to receiving an electric signal. In an example embodiment, drain 24 may further comprise a manual drain valve in addition or as an alternative to automatic water drain valve 152.

FIG. 23 shows a cross-sectional schematic view of an example of water separator 20. In some embodiments, water separator 20 comprises a Parker domnick hunter OIL-X EVOLUTION WS water separator, which utilizes centrifugal technology to provide a more efficient method of bulk liquid removal. Water separator 20 uses a combination of direction change and centrifugal action to effectively separate water from the compressed air flow which travels from intercooler 5 to existing plumbing 7 and main air reservoirs 3 and 4. “Wet” or vapor rich air enters inlet 22 and is directed into the fixed turning vanes of water separator 20, which causes the air to spin inside the vessel and then change direction as it passes the impinge. A vortex is then created which narrows and intensifies as it reaches the lower part of the separator. Bulk liquid is therefore removed from the air stream due to a combination of: 1) directional changes of the air stream; 2) velocity changes; and, 3) centrifugal action of the vortex. As the vortex reaches the bottom of water separator, air is forced through the center of the vortex. Aerospace turning vanes located in outlet 24 of water separator 20 now turn an “inefficient corner” into a number of more “efficient corners” to reduce turbulence, minimize pressure loss, and operational costs. The vapor in the air is thus removed and falls down to drain 26.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

1 Locomotive
2 Deck
3 Main air reservoir
4 Main air reservoir
5 Intercooler
6 Air compressor
7 Existing plumbing
8 Existing plumbing
9 Prior art air braking system
10 Water separator assembly
20 Water separator
22 Inlet
24 Outlet
26 Drain
40 Inlet conduit
42 Flange
43 Reducer
44 Through-bores
46 Fitting
48 Pipe
50 End
52 End
54 Bend
56 Bend
58 Fitting
60 Fitting
62 Elbow
70 Outlet conduit
72 Fitting
74 Fitting
76 Elbow
78 Fitting
80 Fitting
82 Pipe (or hose)
84 Fitting
86 Fitting
88 Elbow
90 Fitting
92 Fitting
100 Bolt
102 Nut
110 Adjustable bracket
112 Vertical member
114 Top
116 Bottom
118 Flange
120 Through-bore
122 Flange
124 Through-bore
126A Slot
126B Slot
128 Base member
130 Horizontal component
132 Vertical component
134A Through-bore
134B Through-bore
140 Heating pad
150 Drain tube
152 Automatic water drain valve
154 Sensor
160 Ambient air temperature switch
200 Circuit breaker box
α Angle
β Angle
γ Angle
δ Angle

What is claimed is:

1. A water separator assembly for an air braking system of a vehicle, comprising:
an inlet conduit;
a water separator connected to the inlet conduit;
an outlet conduit connected to the water separator; and,
an adjustable bracket operatively arranged to connect the water separator to a deck of the vehicle.

2. The water separator assembly as recited in claim 1, wherein the adjustable bracket comprises:
a vertical member operatively arranged to be secured to the water separator; and,
a base member connected to the vertical member, the base member operatively arranged to be connected to the deck of the vehicle.

3. The water separator assembly as recited in claim 2, wherein the vertical member is operatively arranged to displace relative to the base member.

4. The water separator assembly as recited in claim 3, wherein the vertical member is operatively arranged to be fixedly secured to the base member.

5. The water separator assembly as recited in claim 2, wherein the vertical member further comprises at least one flange operatively arranged to secure the water separator to the vertical member.

6. The water separator as recited in claim 2, wherein the base member comprises a vertical component and a horizontal component.

7. The water separator as recited in claim 6, wherein the horizontal component is substantially perpendicular to the vertical component.

8. The water separator as recited in claim 6, wherein the vertical component comprises one or more through-bores.

9. The water separator as recited in claim 8, wherein the vertical member comprises one or more slots operatively arranged to be aligned with the one or more through-bores.

10. The water separator as recited in claim 1, wherein the inlet conduit comprises a flange operatively arranged to be connected to an intercooler of the air braking system.

11. The water separator as recited in claim 10, wherein the inlet conduit further comprises a pipe having one or more bends.

12. The water separator as recited in claim 1, wherein the outlet conduit comprises a fitting operatively arranged to be connected to a main air reservoir of the air braking system.

13. The water separator as recited in claim 1, wherein the water separator comprises a heating pad.

14. The water separator as recited in claim 13, wherein the water separator assembly further comprises an ambient air temperature switch connected to the heating pad, wherein the ambient air temperature switch is operatively arranged to turn the heating pad on when an ambient air temperature falls below a predetermined temperature.

15. The water separator as recited in claim 1, wherein the water separator comprises an automatic drain valve and drain tube connected thereto, wherein a first predetermined criterion is satisfied, the automatic drain valve opens.

16. A water separator assembly for an air braking system of a vehicle, comprising:
an inlet conduit operatively arranged to be connected to an intercooler of the air braking system;
a water separator, including:
an inlet connected to the inlet conduit;
a drain;
a heating pad; and,
an outlet;
an outlet conduit connected to the outlet and operatively arranged to be connected to a main air reservoir of the air braking system; and,
an adjustable bracket operatively arranged to connect the water separator to a deck of the vehicle, the adjustable bracket including:
a vertical member operatively arranged to be secured to the water separator; and,
a base member connected to the vertical member, the base member operatively arranged to be connected to the deck of the vehicle.

17. The water separator assembly as recited in claim 16, wherein the vertical member is operatively arranged to displace relative to the base member.

18. The water separator assembly as recited in claim 17, wherein the vertical member is operatively arranged to be fixedly secured to the base member.

19. The water separator as recited in claim 16, wherein:
the base member comprises one or more through-bores; and,
the vertical member comprises one or more slots operatively arranged to be aligned with the one or more through-bores, the vertical member being adjustable relative to the base member about the one or more slots.

20. The water separator as recited in claim 16, wherein the water separator further comprises an automatic drain valve, wherein a first predetermined criterion is satisfied, the automatic drain valve opens.
